(19) United States
(12) Patent Application Publication
(10) Pub. No.: US 2002/0038852 A1
(43) Pub. Date: Apr. 4, 2002

(54) Magnetic shielding method for charged particle beam microlithography apparatus

(75) Inventor: Shohei Suzuki, Fukaya-shi (JP)

Correspondence Address: KLARQUIST SPARKMAN CAMPBELL, LEIGH & WHINSTON, LLP, One World Trade Center, Suite 1600, 121 S.W. Salmon Street, Portland, OR, 97204, US

(73) Assignee: Nikon Corporation

(21) Appl. No.: 09/908,473

(22) Filed: Jul. 17, 2001

(30) Foreign Application Priority Data
Jul. 18, 2000 (JP) 2000-217181

(51) Int. Cl. H01J 1/52

(52) U.S. Cl. 250/396 ML

(57) ABSTRACT

To provide a method using compact, simple, lightweight apparatus, for canceling the effects, on a charged particle beam optical system, of magnetic fields external to the system, and of fields formed on the outer skin of a beam tube of the particle beam exposure system. External magnetic fields penetrate through the openings A, B, and C to the optical axis of the charged particle beam exposure system, disrupting the operation of the charged particle beam optical system. In this mode of the invention, as shown in the drawing, the coils 5, 6, and 7 are wound horizontally, on the illumination optical system beam tube 1 and the exposure optical system beam tube 2. Currents flowing in these coils can therefore create magnetic fields parallel to the optical axis such as to cancel external magnetic fields in that direction.. Each of the three coils (5, 6, and 7) in FIG. 3 are driven by separate power supplies capable of adjusting the individual coil currents as required to minimize the effects of flux leakage on the beam.

### FIELD

The present invention relates to a method for shielding against undesirable magnetic fields occurring in a charged particle beam exposure system.

### BACKGROUND

A variety of magnetic shields have been developed for use in conventional charged particle beam exposure systems for protecting the optical characteristics of the charged particle beam from degradation by external static and dynamic magnetic fields. For example, the beam tube and chamber might be enclosed in one, two, or three layers of a material that has high initial permeability (such as Permalloy). In addition, the beam tube or chamber itself might be made of Permalloy.

An example of a charged particle exposure system with such conventional magnetic shielding is shown in FIG. 4. This system includes an illumination optical system beam tube 1, an exposure optical system beam tube 2, a vacuum line 3, a wafer chamber 4, and a magnetic shield 13. Item 14 is a charged particle beam source, 15 is a wafer stage, and 16 is a charged particle beam.

An actual beam tube has a number of openings for purposes such as evacuating the system, installation of wiring, and installation of various mechanisms, as shown at A, B, and C. These same openings, then, had to be provided in any covering material provided to shield such a beam tube, and it was almost impossible to avoid dividing the shielding material into multiple pieces.

Cutting holes or dividing the shield material inevitably degraded the shielding properties of the shield, and in many cases it was simply not possible to achieve the level of shielding required by the charged particle beam exposure system. In such cases the room or area in which the exposure system was installed had to be completely enclosed in magnetic shielding material. Such magnetically shielded sealed environments are normally referred to as shield rooms.

Another method consisted of taking coils capable of generating fields in the axial directions of a three-dimensional orthogonal coordinate system, and placing them (at some distance from the beam tube and chamber) such that external magnetic fields would be cancelled out by the fields generated by the coils. A device of this type is referred to as an “active canceller”.

Of those conventional technologies discussed above, we will first consider the problems associated with the method of using shielding material to shield a system from external magnetic fields. In this method, when the beam tube was installed in a poor magnetic environment, or when the beam tube installed was one that was especially sensitive to external magnetic fields, double or triple shielding had to be used, in addition to a shield room. This greatly increased both the weight of the charged particle beam system, and the floor area required to install it, thus creating substantial issues in terms of cost.

The other method, in which an active canceller was used, was effective for an apparatus with a simple shape, such as a simple cylinder. When the shape was complex, however, as are actual charged particle beam exposure systems, or when the external magnetic fields were highly non-uniform, this method, with its limited field-cancellation ability, was incapable of reducing the external magnetic field interference within the beam tube of the charged particle beam exposure system optics to within acceptable levels.

### SUMMARY

The present invention was devised with the above problems in mind. It is therefore an object thereof to provide a method for canceling the influence on a charged particle beam optical system of external magnetic fields, and of magnetic fields formed on the outer skin of a beam tube thereof, using simple, compact, and lightweight apparatus.

In the present invention, the above problem is solved by a magnetic shielding method for a charged particle beam exposure system characterized in that it comprises providing, on or near a beam tube of the charged particle beam exposure system, one or more coils for generating a magnetic field in a prescribed direction; canceling external magnetic fields or magnetic fields formed on the outer skin of the beam tube per se, that penetrate into an optical axis through gaps or openings in the beam tube, by independently controlling electric currents flowing in the individual coils.

In contrast to a conventional active canceller, in this means, one or more coils are provided on or near a beam tube of the charged particle beam exposure system, for generating a magnetic field in a prescribed direction. This placement of the coil near the field to be cancelled makes it possible use smaller coils. Also, where non-uniform external magnetic fields are a problem, coil windings can be customized and coil currents controlled as required to provide adequate cancellation of the external fields. This eliminates the need for special shielding materials, and reduces the amount of floor space required to install the charged particle beam exposure system.

As was done in the past, magnetic sensors may be provided for sensing the magnitudes of external magnetic fields or magnetic fields formed on the outer skin of the beam tube per se, that penetrate into an optical axis through gaps or openings in the beam tube. Sensors may also be provided in locations where a zero magnetic field is desired, so that the currents of individual coils can be controlled to accomplish that objective.

### BRIEF DESCRIPTION of the DRAWINGS

FIG. 1 is a simplified diagram of the apparatus in a first example of a mode for carrying out the charged particle beam exposure system magnetic shielding method of the present invention.

FIG. 2 is a simplified diagram of the apparatus in a second example of a mode for carrying out the charged particle beam exposure system magnetic shielding method of the present invention.

FIG. 3 is a simplified diagram of the apparatus in a third example of a mode for carrying out the charged particle beam exposure system magnetic shielding method of the present invention.

FIG. 4 shows and example of a charged particle exposure system with conventional magnetic shielding.

### DETAILED DESCRIPTION

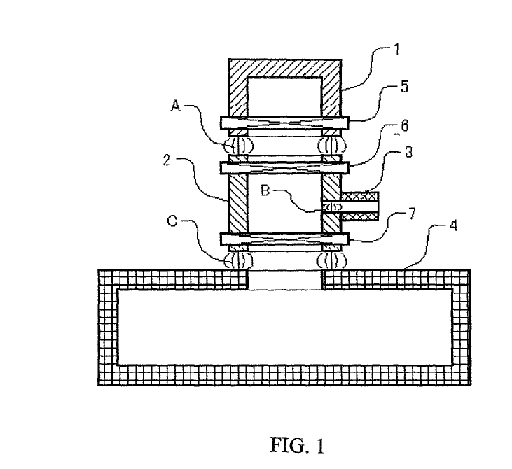

Examples of modes for carrying out the present invention will be described below, with reference to drawings. FIG. 1 is a simplified diagram of the apparatus in a first example of a mode for carrying out the charged particle beam exposure system magnetic shielding method of the present invention. The apparatus of FIG. 1 includes an illumination optical system beam tube 1, an exposure optical system beam tube 2, a vacuum line 3, a wafer chamber 4, coils 5, 6, and 7, and openings A, B, and C.

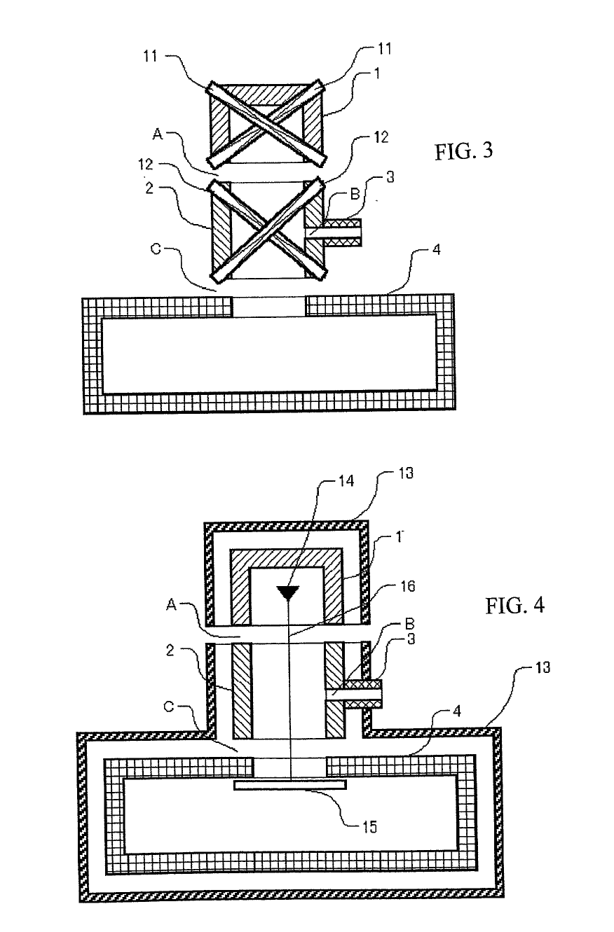

A magnetic field (flux) flowing on the outer skin of the apparatus penetrates through the openings A, B, and C to the optical axis of the charged particle beam exposure system, disrupting the operation of the charged particle beam optical system. In this mode of the invention, as shown in the drawing, the coils 5, 6, and 7 are wound horizontally on the illumination optical system beam tube 1 and the exposure optical system beam tube 2. Currents flowing in these coils can therefore create magnetic fields (indicated in FIG. 1 by the straight and curved lines in the openings A and B) parallel to the optical axis (later to be described as the z axis of a three-dimensional coordinate system) such as to cancel magnetic fields (flux) oriented in the opposite direction on the outer skin. Each of the three coils (5, 6, and 7) in FIG. 3 are driven by separate power supplies capable of adjusting the individual coil currents as required to minimize the effects of flux leakage on the beam.

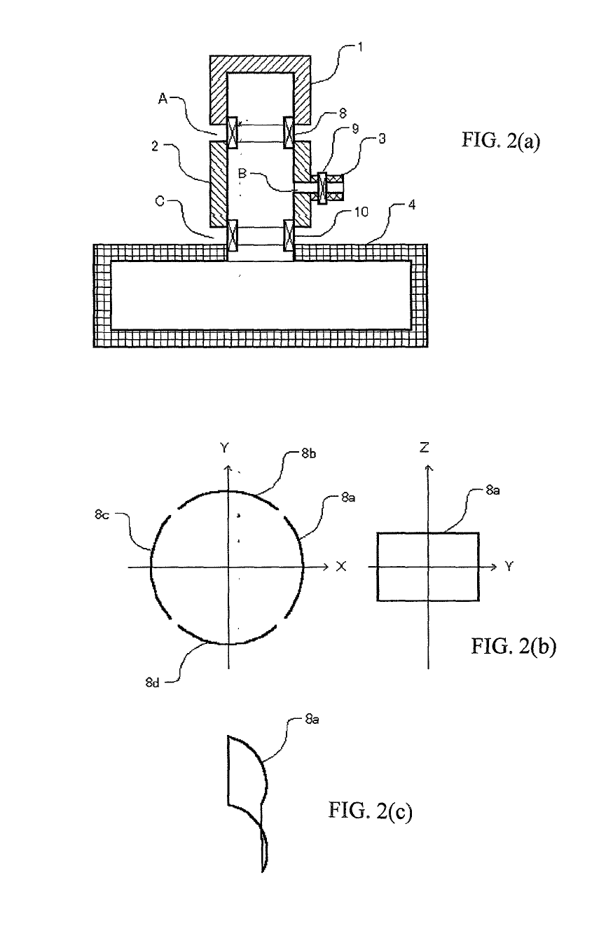

FIG. 2 is a simplified diagram of the apparatus in a second example of a mode for carrying out the charged particle beam exposure system magnetic shielding method of the present invention. In this and subsequent drawings, elements of the configuration that are the same as in earlier drawings are assigned the same reference numbers, and the descriptions of these elements are omitted. In FIG. 2, items 8, 9, and 10 are coils.

The coils 8, 9, and 10 are positioned at the locations of the openings A, B, and C, shown at FIG. 2(a), wound to generate magnetic fields in the horizontal directions (in the x and y axis directions). FIG. 2(b) shows a horizontal cross section of the coil 8 (x-y plane), and a vertical view of the coil 8a in the y-z plane. As shown, the coil 8 is made up of the four coils 8a- 8d. The coils 8a and 8c generate magnetic fields in the x-axis direction, while the coils 8b and 8d generate magnetic fields in the y-axis direction. By individually controlling the currents in these coils, magnetic fields can be generated to cancel horizontal external magnetic fields. The configuration of the coil 10 of FIG. 2(a) is the same. The coil 9 is wound around the vacuum line 3 such as to generate a magnetic field in the x-axis direction, which is the axial direction of the vacuum line 3. FIG. 2(c) shows the shape of the coil 8a, which is the same as that of the coils 8b, 8c, and 8d.

FIG. 3 is a simplified diagram of the apparatus in a third example of a mode for carrying out the charged particle beam exposure system magnetic shielding method of the present invention. In FIG. 3, items 11 and 12 are coils.

As shown in FIG. 3, the coils 11 and 12 are wound diagonally on the beam tubes of the illumination optical system and exposure optical system, respectively. Thus currents flowing in these coils can generate magnetic fields in directions diagonal to the optical axis on the outer skins of the beam tubes. Therefore, when there is a magnetic field (flux) flowing in the outer skin in directions diagonal to the optical axis, such coils can effectively cancel the effects of this outer skin magnetic field.

Described above were examples of coils for generating magnetic fields in the z direction (FIG. 1), in the x and y axis directions (FIG. 2), and in directions diagonal to the z axis (FIG. 3). When external magnetic fields, or magnetic fields (flux), flowing in the outer skin have three-dimensional directional components, a combination of the configurations shown in FIGS. 1 and 2 can be used for cancellation of the three-dimensional fields. By also combining the configuration of FIG. 3, substantially all external magnetic fields and magnetic fields (flux) flowing in the beam tube outer skin can be easily cancelled.

Obviously, even more effective shielding can be achieved by enclosing these field cancellation coils in the same kinds of shielding materials as those used in conventional shielding methods.

As described above, the present invention comprises providing, on or near a beam tube of the charged particle beam exposure system, are one or more coils for generating a magnetic field in a prescribed direction; and independently controlling electric currents flowing in the individual coils; thus providing the capability to sufficiently cancel external magnetic fields and magnetic fields (flux) flowing in the beam tube outer skin, even in the presence of non-uniform external magnetic fields. This can be done using small coils, and without multiple layers of shielding material, thus reducing the amount of space required for charged particle beam exposure system installation.

What is claimed is:

1. A magnetic shielding method for a charged particle beam exposure system characterized by
providing, on or near a beam tube of the charged particle beam exposure system, one or more coils for generating a magnetic field in a prescribed direction; and
canceling external magnetic fields or magnetic fields formed on the outer skin of the beam tube per se, that penetrate into an optical axis through a gap or opening in the beam tube, by independently controlling electric currents flowing in the individual coils.
